(19) United States
(12) Patent Application Publication
(10) Pub. No.: US 2024/0179678 A1
(43) Pub. Date: May 30, 2024

(54) PAGING PROCESSING METHOD, COMMUNICATION DEVICE AND STORAGE MEDIUM

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/553,458

(22) PCT Filed: Apr. 1, 2021
(86) PCT No.: PCT/CN2021/085072

§ 371 Date: Sep. 29, 2023

(51) Int. Cl. H04W 68/02; H04W 8/22; H04W 60/04; H04W 76/20

(52) U.S. Cl. CPC H04W 68/02; H04W 8/22; H04W 60/04; H04W 76/20

(57) ABSTRACT

Provided in the present disclosure are a paging processing method, a communication device and a storage medium. The paging processing method executed by a core network device may include sending a paging message that includes a paging cause.

### CROSS-REFERENCE TO RELATED APPLICATION

The present disclosure is the U.S. National phase application of International Application No. PCT/CN2021/085072, filed on Apr. 1, 2021, the entire content of which is incorporated herein by reference for all purposes.

### BACKGROUND

### Technical Field

The present disclosure relates to, but is not limited to, the field of wireless communication technology, and in particular relates to a paging processing method, a communication device, and a storage medium.

### Description of the Related Art

With the development of wireless communication technology, there are more and more multi-SIM terminals in the market. At present, the processing for multi-SIM terminals is mainly based on the implementations of respective terminal manufacturers, without a unified standard for stipulation, which leads to many different terminal behaviors and processing methods. For example, the communication behavior of a Dual SIM & Single Standby terminal, a Dual SIM & Dual Standby & Single Active terminal, or a Dual SIM & Dual Standby & Dual Active terminal, is very different from the communication behavior of a Single SIM & Single Standby terminal.

### SUMMARY

In the present disclosure, a paging processing method, a communication device, and a storage medium are provided.

According to a first aspect of the present disclosure, a paging processing method is provided, performed by a core network device, the method including: sending a paging message that contains a paging cause.

According to a second aspect of the present disclosure, a paging processing method is provided, performed by a base station, the method including: receiving a paging message containing a paging cause from a core network; and sending the paging message containing the paging cause to a terminal.

According to a third aspect of the present disclosure, a paging processing method is provided, performed by a terminal, the method including: receiving a paging message that contains a paging cause.

According to a fourth aspect of the present disclosure, a communication device is provided, including a processor, a transceiver, a memory and an executable program stored on the memory and capable of being run by the processor, where the processor, when running the executable program, performs the paging processing method as provided in the preceding first aspect or second aspect or third aspect.

According to a fifth aspect of the present disclosure, a non-transitory computer storage medium is provided, the computer storage medium storing an executable program, wherein the executable program, when executed by a processor, enables the paging processing method as provided in the preceding first aspect or second aspect or third aspect to be implemented.

It should be understood that the above general description and the following detailed description are only exemplary and explanatory, and do not limit embodiments of the present disclosure.

### BRIEF DESCRIPTION OF THE DRAWINGS

The accompanying drawings herein, which are incorporated into and form a part of the specification, illustrate principles that are consistent with embodiments of the present disclosure and are used in conjunction with the specification to explain embodiments of the present disclosure.

FIG. 1 is a schematic diagram of a structure of a wireless communication system according to an embodiment.

FIG. 2 is a flowchart of a paging processing method according to an embodiment.

FIG. 3 is a flowchart of a paging processing method according to an embodiment.

FIG. 4 is a flowchart of a paging processing method according to an embodiment.

FIG. 5 is a flowchart of a paging processing method according to an embodiment.

FIG. 6 is a flowchart of a paging processing method according to an embodiment.

FIG. 7 is a flowchart of a paging processing method according to an embodiment.

FIG. 8 is a flowchart of a paging processing method according to an embodiment.

FIG. 9 is a schematic diagram of a structure of a wireless communication system according to an embodiment.

FIG. 10 is a schematic diagram of a structure of a paging processing apparatus according to an embodiment.

FIG. 11 is a schematic diagram of a structure of a paging processing apparatus according to an embodiment.

FIG. 12 is a schematic diagram of a structure of a paging processing apparatus according to an embodiment.

FIG. 13 is a schematic diagram of a structure of a terminal according to an embodiment;

FIG. 14 is a schematic diagram of a structure of a network device according to an embodiment.

### DETAILED DESCRIPTION OF THE PREFERRED EMBODIMENTS

Embodiments will be described herein in detail, examples of which are represented in the accompanying drawings. When the following description relates to the accompanying drawings, the same numerals in the different drawings indicate the same or similar elements unless otherwise indicated. The implementations described in the following embodiments do not represent all implementations consistent with embodiments of the present disclosure. Rather, they are only examples of devices and methods consistent with some aspects of embodiments of the present disclosure as detailed in the appended claims.

Terms in the embodiments of the present disclosure are used solely for the purpose of describing particular embodiments and are not intended to limit the embodiments of the present disclosure. The singular forms of “a/an” and “the” as used in the embodiments of the present disclosure and the appended claims are also intended to include the plural form, unless the context clearly indicates otherwise. It should also be understood that the term “and/or” as used herein refers to and encompasses any or all possible combinations of one or more of the associated listed items.

It should be understood that while the terms “first”, “second”, “third”, etc. may be employed in embodiments of the present disclosure to describe various types of information that should not be limited by these terms. These terms are only used to distinguish the same type of information from each other. For example, without departing from the scope of embodiments of the present disclosure, the first information may also be referred to as the second information, and similarly, the second information may be referred to as the first information. Depending on the context, the phrase “if . . . ” as used herein may be interpreted as “at the time of . . . ” or “when . . . ” or “in response to determining . . . ”

Referring to FIG. 1, it illustrates a schematic diagram of a structure of a wireless communication system provided by embodiments of the present disclosure. As shown in FIG. 1, the wireless communication system is a communication system based on cellular mobile communication technology, and the wireless communication system may include: a plurality of terminals 11 and a plurality of access devices 12.

The terminal 11 may be a device that provides voice and/or data connectivity to a user. The terminal 11 may communicate with one or more core networks via a Radio Access Network (RAN). The terminal 11 may be an IoT terminal, such as a sensor device, a mobile phone (or “cellular” phone), and a computer having an IoT terminal, for example, it may be a fixed, portable, pocket-sized, handheld, computer-integrated, or vehicle-mounted device. For example, it may be a station (STA), a subscriber unit, a subscriber station, a mobile station, a mobile, a remote station, an access point, a remote terminal, an access terminal, a user terminal, a user agent, a user device, or user equipment (terminal). Alternatively, the terminal 11 may be an unmanned aerial vehicle (UAV) device. Alternatively, the terminal 11 may be an in-vehicle device, such as a vehicle computer with wireless communication functions, or a wireless communication device external to the vehicle computer. Alternatively, the terminal 11 may be infrastructure, e.g., it may be a street light, a signal light, or other roadside device with wireless communication functions.

The access device 12 may be a network side device in a wireless communication system. The wireless communication system may be a 4th generation mobile communication (4G) system, also known as a Long Term Evolution (LTE) system; or, the wireless communication system may be a 5G system, also known as a new radio (NR) system or 5G NR system. Alternatively, the wireless communication system may be a further next generation system of the 5G system. In this case, the access network in the 5G system may be called New Generation-Radio Access Network (NG-RAN). Alternatively, it may be a Machine Type of Communication (MTC) system.

The access device 12 may be an evolved Node B (eNB) employed in the 4G system. Alternatively, the access device 12 may be an access device (e.g., gNB) that adopts a centralized and distributed architecture in the 5G system. When the access device 12 adopts a centralized and distributed architecture, it typically includes a central unit (CU) and at least two distributed units (DUs). The central unit is provided with protocol stacks for Packet Data Convergence Protocol (PDCP) layer, Radio Link Control (RLC) layer, and Media Access Control (MAC) layer. The distributed unit is provided with a protocol stack for the physical (PHY) layer. The specific implementation of the access device 12 is not limited by the embodiments of the present disclosure.

A wireless connection may be established between the access device 12 and the terminal 11 via a wireless air interface. In various embodiments, the wireless air interface is based on the fourth generation mobile communication network technology (4G) standard or the fifth generation mobile communication network technology (5G) standard, such as the wireless air interface is a new radio. Alternatively, the wireless air interface may be a wireless air interface based on the next generation mobile communication network technology standard.

In some embodiments, End to End (E2E) connections may also be established between the terminals 11, e.g., vehicle to vehicle (V2V) communication, vehicle to infrastructure (V2I) communication, and vehicle to pedestrian (V2P) communication in vehicle to everything (V2X) and other scenarios.

In some embodiments, the wireless communication system described above may further include a network management device 13.

The plurality of access devices 12 are coupled to the network management device 13, respectively. The network management device 13 may be a core network device in the wireless communication system, for example, the network management device 13 may be a Mobility Management Entity (MME) in an Evolved Packet Core (EPC) network. Alternatively, the network management device may be other core network device such as a Serving GateWay (SGW), a Public Data Network GateWay (PGW), a Policy and Charging Rules Function (PCRF) unit, or a Home Subscriber Server (HSS). The implementation form of the network management device 13 is not limited by the embodiments of the present disclosure.

In related art, most of the behaviors in cellular mobile communication are still designed for Single SIM & Single Standby terminals, which may lead to the non-adaptation of multi-SIM terminals in communication, and thus lead to the problem of poor communication quality or low user satisfaction.

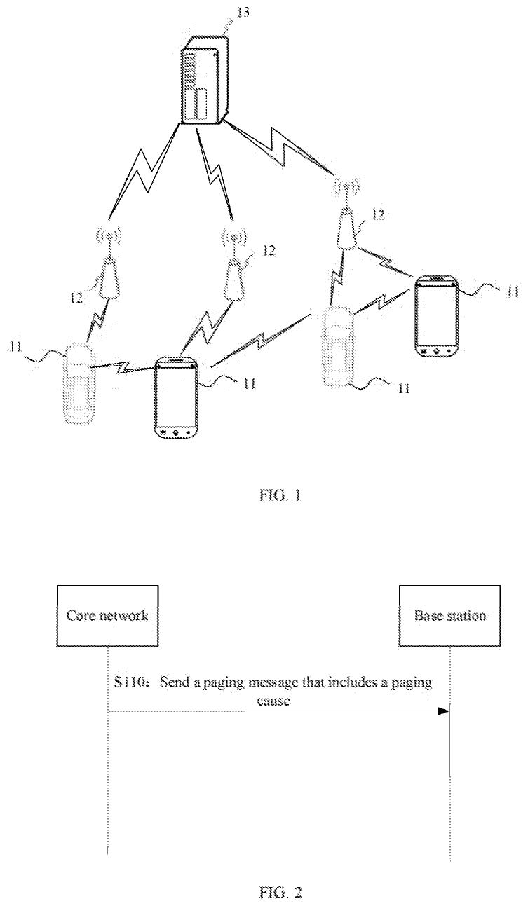

In view of the above, a paging processing method is provided by the embodiments of the present disclosure. As shown in FIG. 2, the method is performed by a core network device, and includes the following step.

S110, sending a paging message that contains a paging cause.

In the embodiments of the present disclosure, the core network device includes, but is not limited to, an Access and Mobility Management Function (AMF), a Mobility Management Entity (MME), and other core network device.

A connection is established between the core network device and a base station of an access network. For example, there may be an N2 interface between the AMF and the base station of the access network. There may be an S1 interface between the MME and the base station.

This paging message that contains the paging cause is sent to the base station.

In some embodiments, if the core network knows whether or not a base station has the capability to send the paging cause to a terminal, the core network may send the paging message that contains the paging cause only to a base station that supports the sending of the paging cause, and send a paging message with no paging cause separately to a base station that does not support the sending of the paging cause. Exemplarily, the base station may report the information to the core network in advance about its capability on whether or not it supports the sending of the paging cause, so that the core network will know whether the base station supports the sending of the paging cause, or, alternatively, so that the core network will know whether the base station currently supports the sending of the paging cause. In other embodiments, the core network may request and obtain information from the network management device about the base station's capability on whether or not the base station supports the sending of the paging cause without the need for the base station itself to report whether or not it supports the sending of the paging cause.

Of course, in some cases, all base stations or some types of the base stations support the sending of the paging cause by default. For example, a 5G base station may support the sending of the paging cause by default. In some other embodiments, it may be determined whether the corresponding base station supports the sending of the paging cause according to the communication protocol. In short, there are many ways for the core network device to determine whether or not the base station supports the sending of the paging cause, which are not limited to any of the above examples.

In other embodiments, the core network device may send the paging message that contains the paging cause directly to the base station without knowing whether or not the current base station supports the sending of the paging cause. After receiving the paging message that contains the paging cause, the base station may send the paging message alone or send the paging message with the paging cause to the terminal, depending on whether it supports the sending of the paging cause. Exemplarily, if the core network device sends the paging message that contains the paging cause to the base station, and the base station itself supports the sending of the paging cause, the base station will send the paging message that contains the paging cause to the terminal. If the base station does not support the sending of the paging cause, the base station will discard the paging cause and send a paging message that does not contain the paging cause to the terminal.

In some embodiments, when the base station discards the paging cause, a result that the paging cause was not sent will be reported to the core network, or will not be reported in other embodiments.

The paging message and the paging cause are sent together, e.g., the paging message is sent with the paging cause corresponding to the paging message. The paging cause herein indicates a cause for the paging that triggers the sending of the paging message.

The paging message herein may at least be used to page a terminal in an idle state, whereby the sending of the paging message triggers the terminal to exit the idle state to enter a connected state, and to perform interaction of various data in the connected state.

In one embodiment, the paging causes are differentiated by type of service including voice services and/or non-voice services.

The service types of the voice services may be further subdivided into: streaming media call services; background call services; and conversational call services.

The service types of the non-voice services may be further subdivided into: Internet access services; video services; file download services; system message updates, and so on.

The above are only some examples of voice services and non-voice services without limitations for specific implementations.

In some embodiments, the base station may carry the paging cause while sending the paging message, and if the paging cause is carried, the terminal being paged will know the cause for this paging, and thus may determine whether to respond to the paging based on the cause for this paging. If the service being paged is not urgent, the terminal can continue to maintain the idle state or the inactive state in such a low-power state, or, without switching the connection, interrupt or pause the current connection established with the other network (or communication system), and establish a connection with the network (or communication system) that sends the paging message.

Exemplarily, the paging cause may carry an identification of the service that triggers the sending of the paging message or a quality of service (QoS) of the service that triggers the sending of the paging message, etc.

In short, the sending of a paging cause may at least enable a specific terminal to determine whether or not to respond to the paging of the corresponding network.

In some embodiments, the specific terminal includes at least a terminal having at least two Subscriber Identity Modules (SIMs).

Some terminals are multi-SIM terminals, and these multi-SIM terminals may be fitted with two or more SIMs, which can be physical SIM cards carried by physical cards, or electronic SIM cards (i.e., eSIM).

In some embodiments, the specific terminal may be a terminal having a capability of connecting to different communication systems. For example, the terminal may be capable of connecting to communication systems of different operators, or, alternatively, to communication systems of different communication standards that are not converged.

In some embodiments of the present disclosure, due to limitations of wireless communication modules such as the number of antennas and/or radio frequency (RF) links, when the specific terminal is communicating with one communication system, if the specific terminal needs to switch to communicating with another communication system, the currently ongoing communication may be affected. Therefore, when the specific terminal is communicating with one communication system, if it receives a paging message from the other communication system and also receives a paging cause, it can determine whether to respond to the paging message or to delay responding to the paging message based on the paging cause.

Exemplarily, the processing for multi-SIM terminals is mainly based on the implementations of various terminal manufacturers, without a unified standard for stipulation, which leads to many different terminal behaviors and processing methods. For example, a Dual SIM & Single Standby terminal, a Dual SIM & Dual Standby & Single Active terminal, or a Dual SIM & Dual Standby & Dual Active terminal, and other terminals, may have one or more of the following problems.
1. When a multi-SIM terminal is in communication with the first communication system, it needs to detect the second communication system from time to time, such as monitoring the paging message of the second communication system, performing measurements on the second communication system, reading the system information of the second communication system, and so on, which may have an impact on the performance of the first communication system.
2. A paging moment is calculated based on the identification of the terminal, and the multi-SIM terminal may cause systematic paging collisions due to multiple SIM cards.
3. When the multi-SIM terminal receives a paging message on the second communication system, it needs to decide whether it needs to respond to the paging message, but this is conducted based on rules configured by the users.
4. When the multi-SIM terminal decides to respond to the paging message from the second communication system, it needs to stop what it is currently doing on the first communication system. If there is no suspension mechanism for the current activity, the terminal will automatically disconnect a radio resource control (RRC) connection with the first communication system and leave. Moreover, after the terminal leaves, the first communication system will continue to page the UE, resulting in a waste of paging resources.
5. When the terminal reads a paging or measures at the second communication system, it will cause a short interval of about 20 ms at the first communication system, which is similar to experiencing shadow fading for the first communication system, but since this occurs once per paging cycle, it may affect the power control and link adaptation algorithms of the network, and consequently cause a waste of resources at the first communication system.
6. When the terminal decides to switch to a cell in the second communication system, the terminal needs to read the system information in the second communication system. This will cause a long interval of about 1 second in the first communication system, which will be considered as an error situation by the first communication system. However, it is uncertain how the terminal and the network will handle this situation.
7. The terminal performing a Tracking Area Update (TAU) in the second communication system will result in longer intervals of several seconds in the first communication system and therefore has a greater impact on the first communication system.

In view of the above, the core network device, by sending a paging message to a specific terminal, may enable the specific terminal to determine whether or not to respond to the paging based on a paging cause, thereby reducing communication interference in another communication system.

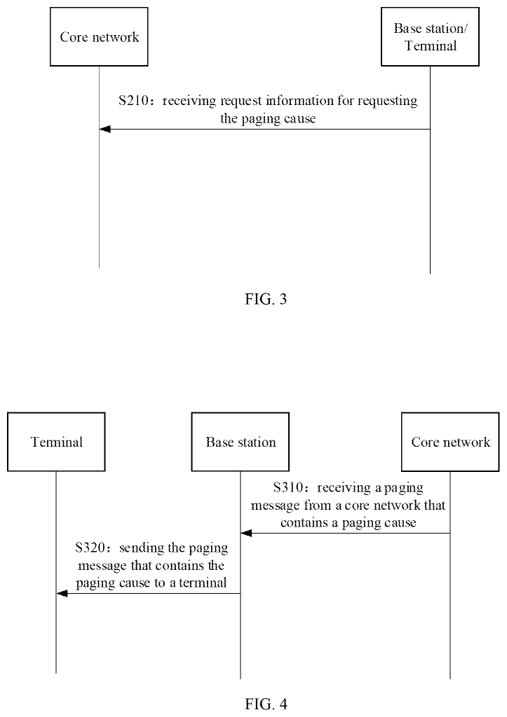

As shown in FIG. 3, a paging processing method is also provided by the embodiments of the present disclosure, which may include the following step.

S210, receiving request information for requesting the paging cause.

The request information may be sent directly by the terminal (transmitted transparently by base station) or forwarded by the base station.

This step S210 may be implemented in combination with S110 shown in FIG. 2, or be implemented alone.

Upon receiving this request information for requesting the paging cause, the core network device can determine whether to agree to send the paging cause to the terminal. For example, the core network device may determine, based on the subscription data of the terminal, whether or not to send the paging message to the terminal with a paging cause for the paging message. For another example, the core network device may determine whether to send the paging cause to the terminal based on a strategy customized by the current core network for sending the paging cause.

In some embodiments, based on a result of determining whether to send the paging cause to the terminal, the core network device will send acknowledged information responding to the request information that requests the paging cause. The acknowledged information may be: an acknowledgement or a negative acknowledgement. If the acknowledged information is an acknowledgement, it means to inform the terminal that the paging cause will be carried in the paging message for sending when the core network is paging the terminal in the future. If the acknowledged information is a negative acknowledgement, it means to inform the terminal that the paging cause will not be sent in the future, and exemplarily, the paging cause will not be sent together with the paging message. By sending the acknowledged information, the terminal can be informed that the request information for requesting the paging cause is sent successfully, so as to reduce the phenomena such as retransmission caused by the terminal mistakenly thinking that the request information for requesting the paging cause is not sent successfully.

In some embodiments, S210 may include: receiving a non-access stratum (NAS) message carrying the request information, where the NAS message is sent by a terminal; or receiving a next generation application protocol (NGAP) message carrying the request information or an S1 application protocol (S1AP) message carrying the request information.

In one embodiment, if the request information for requesting the paging cause is reported directly by the terminal via the transparent transmission of the base station, the message carrying the request information is a NAS message.

In another embodiment, if the request information for requesting the paging cause is forwarded and reported to the core network device by the base station, the message received by the core network is a message from the base station. In this embodiment of the present disclosure, the message received by the core network device from the base station includes, but is not limited to: an NGAP message and/or an S1AP message.

If the current core network device is an AMF, the currently received message is an NGAP message. If the current core network device is an MME, the currently received message is an S1AP message.

In some embodiments, what the core network device can interact with the base station and the terminal, respectively, is the information that is specialized for carrying the request information for requesting the paging cause.

In other embodiments, the request information for requesting the paging cause may be carried in signaling already available in the related art.

Exemplarily, the NAS message includes: an attach request message; and/or a tracking area update (TAU) message; and/or a routing area update (RAU) message.

In the embodiments of the present disclosure, if the core network directly receives a NAS message reported by a terminal, the NAS message may be an attach request message.

The attach request message is a request message reported by the terminal during the attachment process. If the request information for requesting the paging cause is carried in the attach request message, it is equivalent to the terminal requesting the paging cause of the paging message from the core network in the process of initial access, and subsequently, the core network will know whether or not it needs to carry the paging cause at the first paging after the initial access of the terminal.

In the embodiments of the present disclosure, the attach request message is used to carry the request information for requesting the paging cause, and can be used without additional design of NAS signaling to carry such request information, which has the characteristic of strong compatibility with related technologies and is easy to implement.

In some embodiments, the request information for requesting the paging cause may also be carried in the TAU message and/or RAU message.

Exemplarily, the terminal may send the TAU message when a TAU is performed, or, report the TAU message when a timer for the TAU expires, or, the terminal may send the TAU message when there is a need for requesting the paging cause.

In other embodiments, the terminal may carry the request information for requesting the paging cause in the RAU message. Exemplarily, the terminal may send the RAU message when the routing area (RA) is changed, when the timer of the RA expires, or when there is a need to report the request information for requesting the paging cause.

In the embodiments of the present disclosure, the request information for requesting the paging cause is reported via an attach request message, a TAU message and/or a RAU message, without having to be specifically designed to carry the request information for requesting the paging cause. It can realize an abbreviated sending of the request information for requesting the paging cause by using the NAS message in the related art.

Exemplarily, the request information for requesting the paging cause may be carried by a reserved field or reserved bit value in the attach request message, RAU message, and/or TAU message. In some embodiments, one or more new bits may be added to the attach request message, RAU message, and/or TAU message, and the added one or more bits may be used to carry the request information for requesting the paging cause.

In some embodiments, S110 may include: determining, based on the request information, to send the paging cause, and sending the paging message that contains the paging cause.

In some embodiments, the core network device may send the paging cause to all terminals by default. Exemplarily, it sends the paging cause to all terminals or a specific terminal according to the communication protocol. However, in some cases, some terminals may not need the paging cause, e.g., some terminals may respond directly upon receiving the paging message and do not need to determine whether they need to respond to the paging message based on the paging cause. In these cases, when sending the paging message along with the paging cause would result in unnecessary transmissions, and unnecessary signaling overheads incurred by such unnecessary transmissions. In view of the above, when the core network device determines, based on the request information, that the paging cause needs to be sent, it will send the paging cause along with the paging message.

In some embodiments, the request information explicitly indicates a request for the paging cause; or the request information implicitly indicates a request for the paging cause.

In some embodiments of the present disclosure, the request information may be information that is explicitly indicated by one or more bits.

In other embodiments, the request information may be implicitly indicated, such that bit overhead can be saved.

In the case of implicit indication, the information for requesting the paging cause may have a correspondence with other information, so that based on such correspondence, the reporting of the corresponding information is equivalent to implicitly reporting the information for requesting the paging cause.

In some embodiments, in response to determining that the request information implicitly indicates the request for the paging cause, the request information includes at least one of the following information.

First information is the indication information indicating that a terminal is installed with at least two SIMs.

Second information is the first capability information indicating that the terminal has a multi-system communication capability.

Third information is the indication information indicating that there are at least two registered SIMs within the terminal.

Fourth information is the information indicating that the terminal operates in multi-SIM mode.

If at least two SIMs are installed in the terminal, this first information can be reported, so that the core network device, after receiving the indication information, assumes that the terminal will have the request information for requesting the paging cause, which is equivalent to the core network device receiving the request information for requesting the paging cause.

At least two SIMs are installed within the terminal indicated by the first information, and the SIMs indicated by the first information may be SIMs that have been registered to the network or may include a SIM that has not been registered to the network.

The second information may be the first capability information for indicating that the terminal has a multi-system communication capability, e.g., a capability to communicate in the communication networks of different operators. For example, when the terminal has the capability to communicate in at least two of networks of China Mobile Communications Group Co., Ltd, China Telecom Corp Ltd, and China United Network Communication Group Co., Ltd at the same time, the paging cause may be requested to be sent by reporting the second information.

In some embodiments, a plurality of SIMs are installed within the terminal, but some of the plurality of SIMs may not be registered to the network. There may be a relatively urgent need to request the paging cause, only when there are at least two SIMs registered to the network within the terminal. Therefore, in the embodiments of the present disclosure, the third information may indicate that there are at least two SIMs registered to the network within the terminal.

There may be a terminal that supports multi-SIM & multi-standby such as Dual SIM & Dual Standby, but sometimes the terminal does not operate in this mode. Therefore, when the terminal operates in multi-SIM mode, the terminal has a greater demand for requesting the paging cause. The fourth information is the information indicating that the terminal operates in multi-SIM mode.

After the above first to fourth information is reported to the core network and received by the core network device, the core network device will determine that the information for requesting the paging cause is currently received. Any one of the first to fourth information can also be used for other purposes. Therefore, multiple uses for reporting one kind of information are realized, reducing signaling overhead.

As shown in FIG. 4, a paging processing method is provided by the embodiments of the present disclosure. The method is performed by a base station and includes the following steps.

S310, receiving a paging message containing a paging cause from a core network.

S320, sending the paging message containing the paging cause to a terminal.

The base station is a device located in the access network, which can be a 5G base station (gNB) or an evolved base station (eNB), etc.

In the embodiments of the present disclosure, the base station will receive a paging message that contains a paging cause from the core network. In the embodiments of the present disclosure, the paging message that contains the paging cause may be encapsulated by a paging signaling sent by the core network.

After receiving the paging signaling, the base station decodes the paging signaling, extracts the paging identification of the paged terminal and the paging cause from the paging signaling, and constructs a paging message to be sent to the terminal based on the paging identification. The paging message containing the paging cause is formed by the base station re-encapsulating the paging identification and paging cause, and then is sent to the terminal.

The paging message sent from the core network may carry not only the paging identification of the paged terminal, but also the paging priority, and the paging initiator and/or auxiliary information of the paging.

However, the paging message sent from the base station may be simplified to include only the paging identification of the paged terminal.

In the embodiments of the present disclosure, S310 may include: receiving from the core network the paging message that contains the paging cause and is to be sent to a specific terminal. The specific terminal herein may be a terminal installed with at least two SIMs.

After receiving the paging message that contains the paging cause, the base station needs to send the paging message that contains the paging cause to the terminal on Paging Occasion (PO).

In some embodiments, S320 may include: determining that the base station supports the sending of the paging cause, and sending the paging message that contains the paging cause to the terminal.

In some embodiments, the base station may not support the sending of the paging cause because of its own hardware and software. For example, if the base station is not configured with a signaling format for the paging message to contain the paging cause, the base station may not support the sending of the paging cause.

In the embodiments of the present disclosure, the base station sends the paging message containing the paging cause to the terminal only when it supports the sending of the paging cause; otherwise it may merely send a paging message not containing the paging cause even if the paging message containing the paging cause is received from the core network.

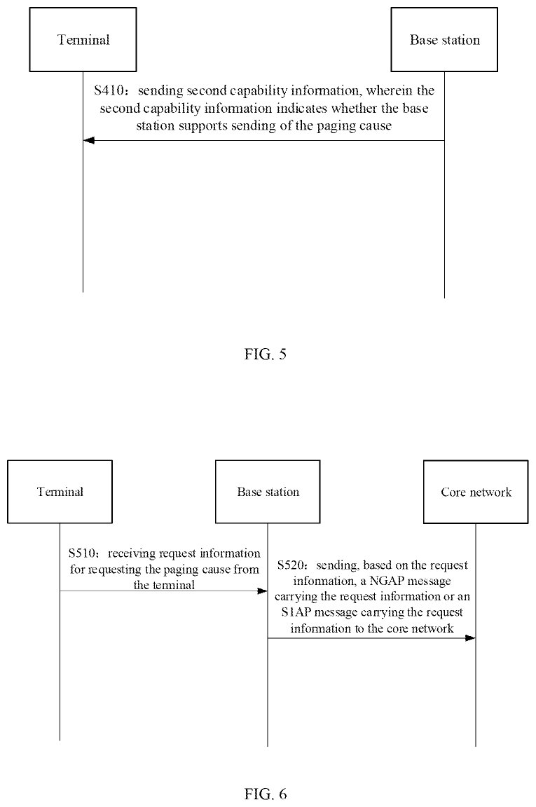

As shown in FIG. 5, a paging processing method is provided by the embodiments of the present disclosure, which may include the following step.

S410, sending second capability information, where the second capability information indicates whether the base station supports the sending of the paging cause.

The second capability information herein may be capability information indicating whether the base station supports the sending of the paging cause. The second capability information herein may indicate that the base station supports the sending of the paging cause, or may indicate that the base station does not support the sending of the paging cause.

This step S410 may be implemented alone or in combination with the aforementioned S310 and/or S320. If S410 is implemented in combination with S310 and/or S320, the request information for requesting the paging cause may be reported by a terminal based on the second capability information which indicates that the base station supports the sending of the paging cause.

Some base stations support the sending of the paging cause, and some base stations do not support the sending of the paging cause. While some base stations temporarily do not support the sending of the paging cause, and in this case, the base station can inform the terminal whether or not it supports the sending of the paging cause by sending capability information.

In some embodiments, a method for processing a paging cause is provided by the embodiments of the present disclosure, which may include: sending, by the base station, the second capability information to the terminal on whether it supports the sending of the paging cause.

The sending of the second capability information facilitates the terminal to determine whether to request for the sending of the paging cause based on whether the base station has the capability to support the sending of the paging cause.

In one embodiment, S410 may include: sending system information carrying the second capability information, or sending a RRC message carrying the second capability information.

The system information is a broadcast message such that all terminals in the cell formed by the base station are able to monitor the second capability information. The RRC message is a unicast message such that the second capability information can be sent to specific terminals in need through the RRC message.

In some embodiments, the second capability information may also be carried in a multicast message, e.g., it may be carried in a group of downlink control information to multicast the second capability information to a specific UE.

In some embodiments, the base station may broadcast the capability information indicating whether the base station supports the sending of the paging cause, or, the base station may multicast the capability information indicating whether the base station supports the sending of the paging cause, or, the base station may unicast the capability information indicating whether the base station supports the sending of the paging cause.

If the base station broadcasts within the cell whether it supports the sending of the paging cause, the capability information can be monitored by all the terminals within the cell.

If the sending of the paging reason cause is designed for specific terminals, the capability information of whether the base station supports the sending of the paging cause can be multicast to the UE group including all specific terminals within the cell, so that only the terminals that need to receive the sent paging cause will receive the capability information, and other terminals can ignore it, which can reduce the information interference.

In addition, the capability information may be carried in the RRC message, which is equivalent to unicasting it to a specific terminal. For example, the terminal will interact with one or more RRC messages when establishing a connection with the base station, and the one or more RRC messages may incidentally carry capability information indicating whether or not the base station supports the sending of the paging cause, e.g., the RRC message may be a signaling transmitted during the establishment of the RRC connection through an access of the terminal to the cell formed by the base station, or may also be capability information carried by the terminal during random access. In this way, the point-to-point sending and receiving of the capability information is realized, the capability information is about whether or not the base station of a single terminal supports the sending of the paging cause, and the capability information is carried in the RRC message having the originally existing function in the related art, which has the characteristic of low signaling overhead. For example, the capability information is carried by using the reserved bits or reserved bit values of RRC messages existing in the related art.

In another embodiment, the second capability information indicating whether the base station supports the sending of the paging cause may also be carried in a dedicated RRC message, which, exemplarily, may be specifically designed to carry the second capability information on whether the base station supports the sending of the paging cause.

In the above example, the terminal and the base station may interact with the second capability information on whether the base station supports the sending of the paging cause when establishing the RRC connection. In other embodiments, the base station may send an RRC message carrying the second capability information to the terminal over the established RRC connection after the terminal has established the RRC connection.

Of course, the base station may send the second capability information to the terminal during the process of disconnecting the RRC connection with the terminal.

Exemplarily, the RRC message may be RRC Reconfiguration signaling or RRC Release signaling.

The step of sending the system information carrying the second capability information includes: sending minimum system information carrying the second capability information; or, sending other system information carrying the second capability information, where the other system information is system information other than the minimum system information.

The base station may send the second capability information about whether it supports the sending of the paging cause via system information.

The system information may be minimum system information (SI), which is always broadcast by the base station. The system information may be other SI. The minimum SI herein includes at least: a Master Information Block (MIB) and a System Information Block 1 (SIB1).

The other system information includes any one or more system information blocks of the MIB and the SIB1.

The base station may send a unicast RRC message to indicate whether it supports the sending of the paging cause.

The multi-SIM terminal obtains information on whether the base station supports the sending of the paging cause.

If the base station can send the minimum SI to indicate whether it supports the sending of the paging cause, the multi-SIM terminal reads the minimum SI directly to obtain the capability information.

The base station may send the other SI to indicate whether it supports the sending of the paging cause.

If the system information carrying the second capability information is sent, the terminal reads the system information directly to obtain the second capability information indicating whether the base station supports the sending of the paging cause.

If the system information indicating whether the base station supports the sending of the paging cause is not sent, the multi-SIM terminal may request the base station to send the system information indicating whether it supports the sending of the paging cause.

That is, when the terminal has not received the capability information indicating whether the base station supports the sending of the paging cause, the terminal may request the base station, via a request message, to send the capability information indicating whether the base station supports the sending of the paging cause.

In view of the above, in some embodiments, the method further include: receiving a request message for the system information.

S410 may include: sending, based on the request message for the system information, the other system information carrying the second capability information.

When the terminal has not monitored the second capability information in the minimum system information, but which system information blocks of the other SI will be sent by the base station can be determined based on the minimum SI, the terminal can request the base station to send the system information block(s) carrying of the second capability information based on the minimum SI, so that the base station, after receiving the request message for requesting the system information, will send the other SI carrying the second capability information based on the request message for the system information.

As shown in FIG. 6, a paging processing method is provided by the embodiments of the present disclosure, which may include the following steps.

S510, receiving request information for requesting the paging cause from the terminal.

S520, sending, based on the request information, a NGAP message carrying the request information for requesting the paging cause, or an S1AP message carrying the request information for requesting the paging cause, to the core network.

In some embodiments, the terminal may send request information for requesting the paging cause, which is not sent directly to the core network via a NAS message, but is first sent to the base station. In this case, the base station may receive and decode the request information, and send the request information to the core network device in the form of a NGAP or SIAP message.

Exemplarily, the request information may be reported by the terminal when the terminal determines, based on the second capability information sent by the base station, that the base station supports the sending of the paging cause. Alternatively, in the case where the base station does not send the second capability information, the base station, after receiving the request information for requesting the paging cause, sends the NGAP message carrying the request information for requesting the paging cause, or the S1AP message carrying the request information for requesting the paging cause, to the core network if the base station determines that it supports the sending of the paging cause.

In some embodiments, if the base station receives the request information for requesting the paging cause after the base station has sent the second capability information, the base station may default that the request information is sent after the terminal determines based on the second capability information that the base station supports the sending of the paging cause, and the base station may directly construct a message to be sent to the core network, and send the request information for requesting the paging cause to the core network by carrying the request information in the message constructed to be sent to the core network.

In other embodiments, if the base station does not send the second capability information, the base station, after receiving the request information for requesting the paging cause reported by the terminal, will determine whether to report the request information for requesting the paging cause from the terminal to the core network according to whether the base station supports the sending of the paging cause. Exemplarily, if the base station does not support the sending of the paging cause, the base station will not report the request information for requesting the paging cause from the terminal to the core network on one hand, and send a rejection message to the terminal on the other hand. Exemplarily, if the base station supports the sending of the paging cause, the base station will report the request information for requesting the paging cause from the terminal to the core network on one hand, and on the other hand, the base station will send acknowledgement information of an acknowledgement of reporting to the terminal, or will not send the acknowledgement information. When no acknowledgement information is sent to the terminal and the terminal has not received a rejection message within a preset time after sending the request information for requesting the paging cause, the request information for requesting the paging cause is reported successfully by default, and the paging cause and the paging message will be sent together when the terminal is paged in the future.

A specific terminal may be a multi-SIM terminal that is required to receive a paging cause.

A paging cause may be sent to the multi-SIM terminal based on the request of the multi-SIM terminal.

After the multi-SIM terminal is informed whether the base station supports the sending of the paging cause, it sends a request to the base station when there is a need to receive the paging cause.

In this case, the terminal receives the second capability information and can determine whether to send the request information for requesting the paging cause according to its own demands.

In some embodiments, the step of sending the request information for requesting the paging cause includes: sending, in response to the terminal having a connection to a first base station based on a first SIM, the request information for requesting the paging cause to a second base station based on a second SIM of the terminal.

The first base station and the second base station herein may be base stations belonging to different communication systems, or, base stations operating different communication systems, or, base stations for building different wireless communication networks.

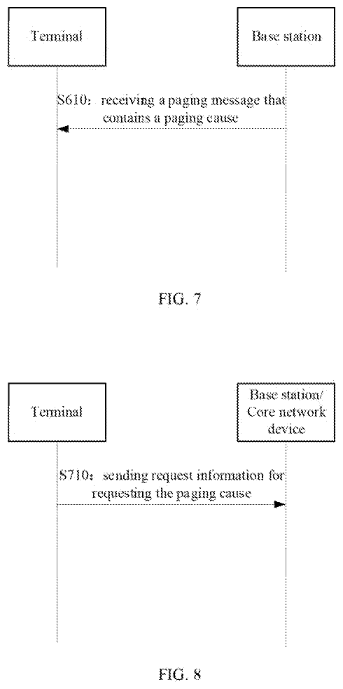

As shown in FIG. 7, a paging processing method is provided by the embodiments of the present disclosure, which is performed by a terminal and includes the following step.

S610, receiving a paging message that contains a paging cause.

The terminal may receive a paging message that contains a paging cause, which is the cause why the paging message is to be sent. The specific content of the paging cause may be: a type identification and/or QoS of the service type that triggers the sending of the paging message, etc.

In embodiments of the present disclosure, the paging message contains the paging cause. That is, the terminal will receive the cause for being paged while being paged. The terminal may be a specific terminal, and the specific terminal includes, but is not limited to: a terminal including a plurality of SIMs.

The terminal may be a terminal in an idle state that receives the paging message and the corresponding paging cause in the idle state.

As shown in FIG. 8, a paging processing method is provided by the embodiments of the present disclosure, which may include the following step.

S710, sending request information for requesting the paging cause.

The terminal may send the information for requesting the paging cause directly to the base station or the core network.

Exemplarily, the terminal determines that it is a multi-SIM terminal. Since there exists a phenomenon that an immediate response to a paging message received by a SIM during communication may cause a communication interruption of another SIM currently in communication, the terminal may send request information for requesting a paging cause to the base station and/or the core network, so that the paging cause is also carried when sending the paging message, and the terminal may determine whether it is necessary to respond to the paging message immediately or not to respond to the paging message or to delay responding to the paging message in accordance with the paging cause.

If the terminal does not respond to the paging message and the network side does need to call the terminal, the network side will continue to send the paging message so that the terminal will receive and respond to the paging message when it is appropriate to receive the paging message.

If the terminal does not currently respond to the paging message, it may respond at one or more response times other than any one of the response times within a specific time period agreed upon with the base station, so that the number of paging messages sent from the network side can be reduced.

Exemplarily, the step of sending the request information for requesting the paging cause includes: sending a NAS message carrying the request information for requesting the paging cause; or sending a RRC message carrying the request information for requesting the paging cause, where the request information for requesting the paging cause, is configured for a base station to send a NGAP message carrying the request information or an STAP message carrying the request information to a core network.

The NAS message is a message reported directly from the terminal to the core network.

The RRC message may be a message sent by the terminal to the base station. The RRC message may be: an RRC message sent during the process of the UE releasing the RRC connection and entering into the idle state, or an RRC message sent during the process of the UE establishing an RRC connection with the base station from the idle state or the inactive state, or an RRC message sent when the terminal is in the connected state with an RRC connection established between the terminal and the base station.

Exemplarily, the RRC message may be an RRC Reconfiguration message, an RRC Release message, or an RRC Connection message.

In some embodiments, the NAS message includes: an attach request message; and/or a TAU message; and/or a RAU message.

Related descriptions of the attach request message, the TAU message, and the RAU message herein can be found in the corresponding portions of the preceding embodiments and will not be repeated herein.

In some embodiments, the request information explicitly indicates a request for the paging cause; or the request information implicitly indicates a request for the paging cause.

The request information reported by the terminal for requesting the paging cause may be explicitly indicated through one or more bits, or may implicitly indicate that the terminal requests to send the paging cause through information about a correspondence or association relationship between messages.

In some embodiments, in response to determining that the request information implicitly indicates the request for the paging cause, the request information includes at least one of the following information.

First information is the indication information indicating that the terminal is installed with at least two SIMs.

Second information is the first capability information indicating that the terminal has a multi-system communication capability.

Third information is the indication information indicating that there are at least two registered SIMs within the terminal.

Fourth information is the information indicating that the terminal operates in multi-SIM mode.

Related descriptions of the first to fourth information herein can be found in the corresponding portions of the preceding embodiments and will not be repeated herein.

In some embodiments, the method further includes: receiving second capability information, where the second capability information indicates whether a base station supports sending of the paging cause.

The second capability information is sent by the base station which indicates whether the base station supports the sending of the paging cause. By receiving the second capability information, the terminal can be informed whether or not the base station supports the sending of the paging cause. If the base station does not support the sending of the paging cause, the network side will not send the paging cause even if the terminal requests the sending of the paging cause. If the base station supports the sending of the paging cause, the terminal can determine whether to request the sending of the paging cause according to its own demands.

In some embodiments, the step of sending the request information for requesting the paging cause includes: sending, in response to the second capability information indicating that the base station supports the sending of the paging cause, the request information for requesting the paging cause.

If the second capability information sent by the base station is received, and it is determined that the base station supports the sending of the paging cause according to the second capability information, the terminal can send the request information for requesting the paging cause according to its own demands when there is a need for requesting the sending of the paging cause. In this way, the unnecessary sending of request information is reduced.

In some embodiments, the step of sending the request information for requesting the paging cause includes: sending, in response to a first SIM of the terminal having a connection to a first base station, the request information for requesting the paging cause to a network to which a second SIM of the terminal is connected via the second SIM.

In the embodiments of the present disclosure, a connection will be only established between the first SIM and the first base station, and the request information for requesting the paging cause will be sent to the network to which the second SIM is connected via the second SIM. Exemplarily, the second SIM is connected to a second base station, which is different from the first base station. The second base station and the first base station belong to different communication systems, or the second base station and the first base station are base stations that operate different communication mechanisms.

In this manner, after the first SIM has established a connection with the first base station and the second SIM has entered an idle state, if a paging message sent by the network to which the second SIM is registered is received together with a paging cause, whether to respond to the paging of the second SIM can be determined in accordance with the paging cause, thereby reducing the phenomenon in which the connection between the first SIM and the first base station is interrupted due to the second SIM responding immediately to a paging message upon receiving the paging message.

In some embodiments, the step of sending, in response to the first SIM of the terminal having the connection to the first base station, the request information for requesting the paging cause to the network to which the second SIM of the terminal is connected via the second SIM, includes: sending, in response to the first SIM of the terminal having the connection to the first base station and there being a transmission on the connection, the request information for requesting the paging cause to the network to which the second SIM of the terminal is connected via the second SIM.

The terminal herein supports the establishment of a connection with a plurality of base stations in different communication systems or different communication networks. When a current SIM (i.e., the first SIM) has already established a connection with a base station in a certain communication system or network, and another SIM (i.e., the second SIM) receives a paging message of a paging cause from another communication system or network, it may lead to the problem that the second SIM will compete with the first SIM for the hardware and software resources of the terminal if the second SIM immediately responds to the paging message from the second base station, thereby causing the connection between the first SIM and the first base station to be disconnected or invalid. If, at this time, the connection established between the first SIM and the first base station has data in transmission, or immediately has data in transmission, this may lead to interruptions in the service in which the first SIM is involved in communication, or the like.

In some embodiments, the step of sending, in response to the first SIM of the terminal having the connection to the first base station, the request information for requesting the paging cause to the network to which the second SIM of the terminal is connected via the second SIM, includes: sending, in response to the first SIM of the terminal having the connection to the first base station and there being a transmission on the connection, the request information for requesting the paging cause to the network to which the second SIM of the terminal is connected via the second SIM.

The content transmitted over the connection may include: control-plane signaling and/or user-plane data.

When the second SIM receives a paging message from the second base station while there is a connection established between the first SIM and the first base station, the connection between the first SIM and the first base station will be invalidated if the second SIM responds to the paging message. However, if the paging message is received from the second base station that carries a paging cause for the paging message, the terminal can control the second SIM to respond to the paging message immediately, or not to respond to the paging message or to delay responding to the paging message, depending on the paging cause. In this way, unnecessary disconnection of the connection between the first SIM and the first base station can be reduced.

In some embodiments, the method further includes: in response to the terminal having a connection with the first base station via the first SIM, and a priority of a service that triggers the sending of the paging message indicated by the paging cause being higher than a priority of data transmitted over the connection between the first SIM and the first base station, or being higher than a priority of data about to be transmitted over the connection between the first SIM and the first base station, responding to the paging message from the second base station; otherwise, not responding to the paging message from the second base station.

In other embodiments, the method further includes: in response to the terminal having a connection with the first base station via the first SIM, determining, based on the paging cause sent by the second base station, that a service which triggers the second base station to send the paging message is a preset service, and responding to the paging message from the second base station; otherwise not responding to the paging message from the second base station.

The preset service includes, but is not limited to: a voice called service or an Ultra Reliable Low Latency Communication (URLLC) service, etc.

The first base station and second base station in the embodiments of the present disclosure may be base stations of different communication operators, or base stations of different systems or base stations of different networks.

As shown in FIG. 9, base station #2 supports the sending of the paging cause. SIM #1 among the multi-SIM terminals is transmitting data with base station #1. After SIM #2 learns that base station #2 supports the sending of the paging cause, it can send a request signaling to base station #2 for requesting base station #2 to send the paging cause while paging SIM #2.

In the embodiments of the present disclosure, the multi-SIM terminal may decide which services to respond to according to the paging cause supported by the base station, provided that the network side will send the paging cause to the multi-SIM terminal. In view of this, the multi-SIM terminal sends request information for the paging cause to the core network. This request information can be sent directly from the terminal to the core network via a NAS message, e.g., it can be added to an attach request signaling.

The request information may be an explicit request, e.g., a paging cause request message is sent directly.

The request information may be an implicit request, e.g. information about the multi-SIM capability of the terminal is sent to the core network.

The request can be sent via an RRC message to the base station, and then sent by the base station to the core network.

After the core network receives the paging cause request sent by the multi-SIM terminal, if it agrees to the request, it adds the corresponding paging cause to the paging signaling to be sent to the base station when paging the terminal.

After the base station receives a paging signaling containing the paging cause for a multi-SIM terminal, it sends the paging signaling containing the paging cause to the multi-SIM terminal.

As shown in FIG. 9, SIM #2 is connected to base station #2 and core network #2, while SIM #1 is connected to base station #1. UE can request the paging cause from core network #2 directly via a NAS message or an RRC message, or UE can request the paging cause from the core network based on the forwarding of base station #2 via an RRC message. Prior to this, the base station can also send capability information to the terminal about whether the base station supports the sending of the paging cause.

The base station can send system information about whether it supports the sending of the paging cause.

This system information can be minimum SI, which is always broadcast by the base station.

This system information can be other SI.

The base station may send a unicast RRC message to indicate whether it supports the sending of the paging cause.

The multi-SIM terminal obtains information on whether the base station supports the sending of the paging cause.

If the base station can send the minimum SI to indicate whether it supports the sending of the paging cause, the multi-SIM terminal reads the minimum SI directly to obtain the capability information.

The base station may send the other SI to indicate whether it supports the sending of the paging cause.

If the system information indicating whether the base station supports the sending of the paging cause is sent, the multi-SIM terminal reads the system information directly to obtain the capability information on whether the base station supports the sending of the paging cause.

If the system information indicating whether the base station supports the sending of the paging cause is not sent, the multi-SIM terminal may request the base station to send the system information indicating whether it supports the sending of the paging cause.

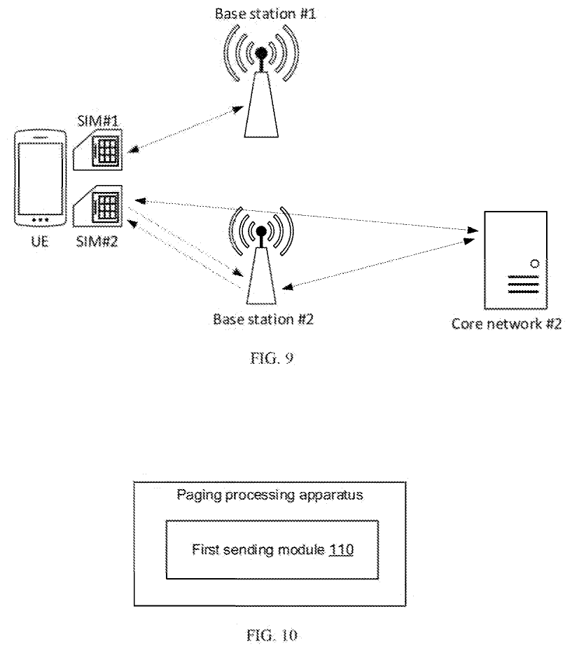

As shown in FIG. 10, a paging processing apparatus is provided by embodiments of the present disclosure. The apparatus is included in a core network device and includes: a first sending module 110 configured to send a paging message that contains a paging cause.

The core network device includes, but is not limited to, an AMF and/or MME, etc.

The apparatus includes the first sending module 110 that will send a paging message containing a paging cause.

In some embodiments, the first sending module 110 may be a programming module.

The programming module, when executed by the processor, enables the sending of the paging message containing the paging cause.

In other embodiments, the first sending module 110 may be a module combining hardware and software, which includes, but is not limited to: a programmable array. The programmable array includes, but is not limited to: a field programmable array and/or a complex programmable array.

In still other embodiments, the first sending module 110 may be a pure hardware module, which includes, but is not limited to: a dedicated integrated circuit.

In some embodiments, the apparatus further includes a first receiving module configured to receive request information for requesting the paging cause.

In some embodiments, the first receiving module is configured to receive a non-access stratum (NAS) message carrying the request information, wherein the NAS message is sent by a terminal; or receive a next generation application protocol (NGAP) message carrying the request information or an S1 application protocol (S1AP) message carrying the request information.

In some embodiments, the NAS message includes: an attach request message; and/or a tracking area update (TAU) message; and/or a routing area update (RAU) message.

In some embodiments, the first sending module 110 is configured to determine, based on the request information, to send the paging cause, and send the paging message that contains the paging cause.

In some embodiments, the request information explicitly indicates a request for the paging cause; or the request information implicitly indicates a request for the paging cause.

In some embodiments, in response to determining that the request information implicitly indicates the request for the paging cause, the request information comprises at least one of: first information indicating that a terminal is installed with at least two subscriber identity modules (SIMs); second information being first capability information indicating that the terminal has a multi-system communication capability; third information indicating that there are at least two registered SIMs within the terminal; and fourth information indicating that the terminal operates in multi-SIM mode.

As shown in FIG. 11, a paging processing apparatus is provided by embodiments of the present disclosure. The apparatus is included in a base station and includes: a second receiving module 210 configured to receive a paging message containing a paging cause from a core network; and a second sending module 220 configured to send the paging message containing the paging cause to a terminal.

The paging processing apparatus is included in a base station, which may be a gNB or an eNB.

In some embodiments, the second receiving module 210 and the second sending module 220 may be programming modules which, when executed by the processor, enable receiving the paging message that contains the paging cause from the core network and sending the paging message and the paging cause to the terminal.

In other embodiments, the second receiving module 210 and the second sending module 220 may be modules combining hardware and software, which include, but are not limited to, a variety of programmable arrays. The programmable arrays include, but are not limited to: field programmable arrays and/or complex programmable arrays.

In some embodiments, the second receiving module 210 and the second sending module 220 may be pure hardware modules, which include, but are not limited to: dedicated integrated circuits.

In some embodiments, the second sending module 220 is configured to determine that the base station supports the sending of the paging cause, and send the paging message that contains the paging cause to the terminal.

In some embodiments, the second sending module 220 is further configured to send second capability information, wherein the second capability information indicates whether the base station supports the sending of the paging cause.

In some embodiments, the second sending module 220 is configured to send system information carrying the second capability information; or send a radio resource control (RRC) message carrying the second capability information.

In some embodiments, the second sending module 220 is configured to send minimum system information carrying the second capability information; or send other system information carrying the second capability information, wherein the other system information is system information other than the minimum system information.

In some embodiments, the second receiving module 210 is further configured to receive a request message for the system information; and the second sending module 220 is configured to send, based on the request message for the system information, the other system information carrying the second capability information.

In some embodiments, the second receiving module 210 is configured to receive request information for requesting the paging cause from the terminal; and the second sending module 220 is further configured to send, based on the request information, a next generation application protocol (NGAP) message carrying the request information or an S1 application protocol (S1AP) message carrying the request information to the core network.

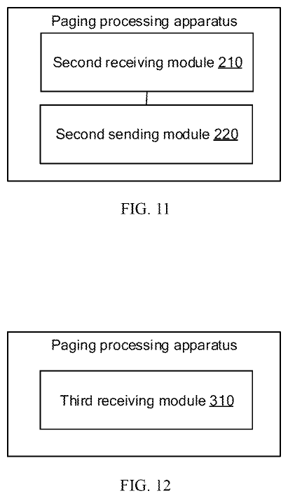

As shown in FIG. 12, a paging processing apparatus is provided by embodiments of the present disclosure. The apparatus is included in a terminal and includes: a third receiving module 310 configured to receive a paging message that contains a paging cause.

In some embodiments, the third receiving module 310 may be a programming module. The programming module, when executed by the processor, enables receiving the paging message that contains the paging cause from the base station.

In other embodiments, the third receiving module 310 may include a module combining hardware and software, which includes, but is not limited to: a programmable array. The programmable array includes, but is not limited to: a field programmable array and/or a complex programmable array.

In still other embodiments, the third receiving module 310 may include a pure hardware module, which includes, but is not limited to: a dedicated integrated circuit.

In some embodiments, the apparatus further includes a third sending module configured to send request information for requesting the paging cause.

Similarly, the third sending module may be at least one of a programming module, a module combining hardware and software and/or a pure hardware module.

In some embodiments, the third sending module is configured to send a non-access stratum (NAS) message carrying the request information; or send a radio resource control (RRC) message carrying the request information, wherein the request information for requesting the paging cause, is configured for a base station to send a next generation application protocol (NGAP) message carrying the request information or an S1 application protocol (S1AP) message carrying the request information to a core network.

In some embodiments, the NAS message includes: an attach request message; and/or a tracking area update (TAU) message; and/or a routing area update (RAU) message.

In some embodiments, the request information explicitly indicates a request for the paging cause; or the request information implicitly indicates a request for the paging cause.

In some embodiments, in response to determining that the request information implicitly indicates the request for the paging cause, the request information includes at least one of: first information indicating that the terminal is installed with at least two subscriber identity modules (SIMs); second information being first capability information indicating that the terminal has a multi-system communication capability; third information indicating that there are at least two registered SIMs within the terminal; and fourth information indicating that the terminal operates in multi-SIM mode.

In some embodiments, the third receiving module 310 is further configured to receive second capability information, wherein the second capability information indicates whether a base station supports sending of the paging cause.

In some embodiments, the third sending module is configured to send, in response to the second capability information indicating that the base station supports the sending of the paging cause, the request information for requesting the paging cause.

In some embodiments, the third sending module is configured to send, in response to a first SIM of the terminal having a connection to a first base station, the request information for requesting the paging cause to a network to which a second SIM of the terminal is connected via the second SIM.

In some embodiments, the third sending module is configured to send, in response to the first SIM of the terminal having the connection to the first base station and there being a transmission on the connection, the request information for requesting the paging cause to the network to which the second SIM of the terminal is connected via the second SIM.

In the technical solutions provided by the embodiments of the present disclosure, the core network can send the paging message that contains the paging cause, so that after the paging message is forwarded by the base station, the terminal will receive the paging message containing the paging cause. The terminal will determine whether to respond to the paging message, respond to the paging message immediately, or delay responding to the paging message according to the received paging cause, thereby reducing the phenomenon of interruption of other transmission of the terminal device caused by the necessary of responding uniformly and immediately to the paging message when being paged, and improving the overall communication quality of the terminal and the goodness of the user experience.

A communication device is provided by embodiments of the present disclosure, including a memory for storing instructions executable by a processor; and a processor connected to the memory.

The processor is configured to perform the paging processing methods provided by any of the preceding technical solutions.

The processor may include various types of storage medium that are non-transitory computer storage medium capable of continuing to memorize information stored thereon after the communication device is powered down.

The communication device herein includes: an access device or terminal or a core network device.

The processor may be connected to the memory, e.g. via a bus, for reading an executable program stored on the memory, to implement the paging processing methods provided by any of the preceding technical solutions, e.g. at least one of the methods as shown in FIGS. 2 to 8.

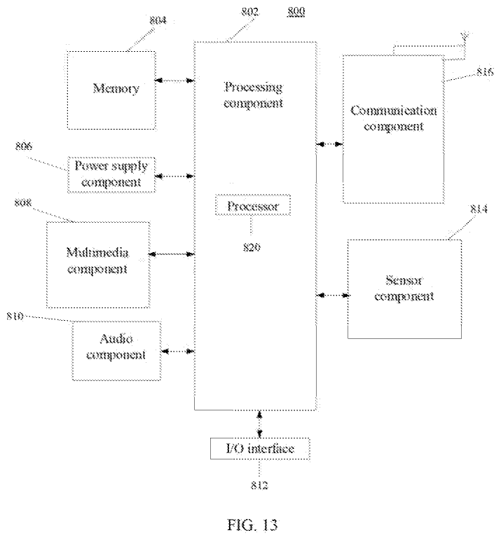

FIG. 13 is a schematic block diagram of a terminal 800 according to an embodiment. For example, the terminal 800 may be a cell phone, a computer, a digital broadcast terminal, a message sending and receiving device, a game console, a tablet device, a medical device, a fitness device, a personal digital assistant, etc.

Referring to FIG. 13, the terminal 800 may include one or more of the following components: processing component 802, memory 804, power supply component 806, multimedia component 808, audio component 810, input/output (I/O) interface 812, sensor component 814, and communication component 816.

The processing component 802 generally controls the overall operation of the terminal 800, such as operations associated with display, telephone call, data communication, camera operation, and recording operations. The processing component 802 may include one or more processors 820 to execute instructions to complete all or some of the steps of the methods described above. In addition, the processing component 802 may include one or more modules that facilitate interaction between processing component 802 and other components. For example, the processing component 802 may include a multimedia module to facilitate interaction between the multimedia component 808 and the processing component 802.

The memory 804 is configured to store various types of data to support operation at the terminal 800. Examples of such data include instructions for any application or method operating on the terminal 800, contact data, phonebook data, messages, pictures, videos, etc. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, Disk or CD-ROM.

The power supply component 806 provides power to various components of the terminal 800. The power supply component 806 may include a power management system, one or more power supplies, and other components associated with generating, managing, and distributing power for the terminal 800.

The multimedia component 808 includes a screen that provides an output interface between the terminal 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense the boundaries of the touch or swipe action, but also detect the duration and pressure associated with the touch or swipe action. In some embodiments, the multimedia component 808 includes a front-facing camera and/or a rear-facing camera. The front-facing camera and/or rear-facing camera can receive external multimedia data when the terminal 800 is in an operating mode, such as shooting mode or video mode. Each front-facing camera and rear-facing camera may be a fixed optical lens system or have focal length and optical zoom capability.

The audio component 810 is configured to output and/or input audio signals. For example, the audio component 810 includes a microphone (MIC) configured to receive external audio signals when the terminal 800 is in an operating mode, such as call mode, record mode, and voice recognition mode. The received audio signal may be further stored in memory 804 or sent via communication component 816. In some embodiments, the audio component 810 further includes a speaker for outputting the audio signal.

The I/O interface 812 provides an interface between the processing component 802 and the peripheral interface modules, and the peripheral interface modules may be keypads, click wheels, buttons, etc. These buttons may include, but are not limited to: home button, volume button, start button, and lock button.

The sensor component 814 includes one or more sensors for providing status assessment of various aspects of the terminal 800. For example, the sensor component 814 may detect an open/closed state of the terminal 800, the relative positioning of components, such as the components being the display and keypad of the terminal 800, and the sensor component 814 may also detect a change in position of the terminal 800 or a component of the terminal 800, the presence or absence of user contact with the terminal 800, the orientation or acceleration/deceleration of the terminal 800, and temperature changes of the terminal 800. The sensor component 814 may include a proximity sensor configured to detect the presence of nearby objects in the absence of any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication between the terminal 800 and other devices by wired or wireless means. The terminal 800 may access a wireless network based on any communication standard such as Wi-Fi, 2G or 3G, 4G LTE, 5G NR, or a combination thereof. In one embodiment, the communication component 816 receives broadcast signals or broadcast-related information from an external broadcast management system via a broadcast channel. In an embodiment, the communication component 816 further includes a near-field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In embodiments, the terminal 800 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing the above methods.

In embodiments, there is also provided a non-transitory computer-readable storage medium including instructions, such as a memory 804 including instructions, the instructions being executable by the processor 820 of the terminal 800 to accomplish the methods described above. For example, the non-transitory computer-readable storage medium may be ROM, random access memory (RAM), CD-ROM, magnetic tape, floppy disk, and optical data storage device, among others.

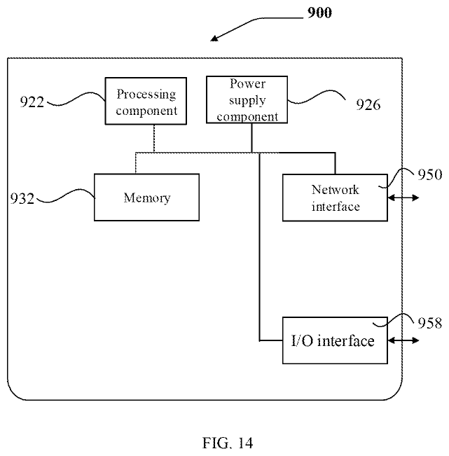

As shown in FIG. 14, a structure of a network device is illustrated by an embodiment of the present disclosure. For example, a network device 900 may be provided as a network side device. The communication device may be an access device and/or a core network device as previously described.

Referring to FIG. 14, the network device 900 includes a processing component 922 which further includes one or more processors, and memory resources represented by a memory 932 for storing instructions, such as applications, that may be executed by the processing component 922. The application programs stored in memory 932 may include one or more modules each corresponding to a set of instructions. In addition, the processing component 922 is configured to execute instructions to perform the foregoing methods, any of which is applied to the access device, for example, such as the methods shown in FIGS. 2 to 9.

The network device 900 may also include a power supply component 926 configured to perform power management of the network device 900, a wired or wireless network interface 950 configured to connect the network device 900 to a network, and an input/output (I/O) interface 958. The network device 900 may operate an operating system based on the operating system stored in the memory 932, such as Windows Server™, Mac OS X™, Unix™, Linux™, FreeBSD™ or the like.

Other embodiments of the present disclosure will readily come to mind to those skilled in the art upon consideration of the specification and practice of the invention disclosed herein. The present disclosure is intended to cover any variations, uses, or adaptations of this invention that follow the general principles of this invention and include means of common knowledge or customary skill in the art not disclosed herein. The specification and embodiments are to be regarded as exemplary only, and the true scope and spirit of the invention is indicated by the following claims.

It should be understood that this invention is not limited to the precise structure which has been described above and illustrated in the accompanying drawings, and that various modifications and changes may be made without departing from its scope. The scope of this invention is limited only by the appended claims.

1. A paging processing method, comprising:
sending, by a core network device, a paging message that contains a paging cause.

2. The method of claim 1, further comprising:
receiving request information for requesting the paging cause.

3. The method of claim 1, wherein receiving the request information for requesting the paging cause, comprises:
receiving a non-access stratum (NAS) message carrying the request information, wherein the NAS message is sent by a terminal; or
receiving a next generation application protocol (NGAP) message carrying the request information or an SI application protocol (S1AP) message carrying the request information.

4. The method of claim 3, wherein the NAS message comprises at least one of:
an attach request message;
a tracking area update (TAU) message; and
a routing area update (RAU) message.

5. The method of claim 2, wherein sending the paging message that contains the paging cause, comprises:
sending the paging message that contains the paging cause upon determining to send the paging cause based on the request information.

6-7. (canceled)

8. A paging processing method, comprising:
receiving, by a base station, a paging message containing a paging cause from a core network; and
sending, by the base station, the paging message containing the paging cause to a terminal.

9. The method of claim 8, wherein sending the paging message that contains the paging cause to the terminal, comprises:
sending the paging message that contains the paging cause to the terminal upon determining that the base station supports sending the paging cause.

10. The method of claim 8, further comprising:
sending second capability information, wherein the second capability information indicates whether the base station supports the sending of the paging cause.

11. The method of claim 10, wherein sending the second capability information, comprises:
sending system information carrying the second capability information; or
sending a radio resource control (RRC) message carrying the second capability information.

12-13. (canceled)

14. The method of claim 8, further comprising:
receiving request information for requesting the paging cause from the terminal; and
sending, based on the request information, a next generation application protocol (NGAP) message carrying the request information or an S1 application protocol (S1AP) message carrying the request information to the core network.

15. A paging processing method comprising:
receiving, by a terminal, a paging message that contains a paging cause.

16. The method of claim 15, further comprising:
sending request information for requesting the paging cause.

17. The method of claim 16, wherein sending the request information for requesting the paging cause, comprises:
sending a non-access stratum (NAS) message carrying the request information; or
sending a radio resource control (RRC) message carrying the request information, wherein the request information for requesting the paging cause, is configured for a base station to send a next generation application protocol (NGAP) message carrying the request information or an S1 application protocol (S1AP) message carrying the request information to a core network.

18. The method of claim 17, wherein the NAS message comprises at least one of:
an attach request message;
a tracking area update (TAU) message; and
a routing area update (RAU) message.

19-20. (canceled)

21. The method of claim 16, further comprising:
receiving second capability information, wherein the second capability information indicates whether a base station supports sending of the paging cause.

22. The method of claim 21, wherein sending the request information for requesting the paging cause, comprises:
sending, in response to the second capability information indicating that the base station supports the sending of the paging cause, the request information for requesting the paging cause.

23. The method of claim 16,
wherein sending the request information for requesting the paging cause, comprises:
sending, in response to a first SIM of the terminal having a connection to a first base station, the request information for requesting the paging cause to a network to which a second SIM of the terminal is connected via the second SIM.

24. The method of claim 23, wherein sending, in response to the first SIM of the terminal having the connection to the first base station, the request information for requesting the paging cause to the network to which the second SIM of the terminal is connected via the second SIM, comprises:
sending, in response to the first SIM of the terminal having the connection to the first base station and there being a transmission on the connection, the request information for requesting the paging cause to the network to which the second SIM of the terminal is connected via the second SIM.

25-48. (canceled)

49. A communication device, comprising a processor, a transceiver, a memory and an executable program stored on the memory and capable of being run by the processor, wherein the processor, when running the executable program, performs the method of claim 1.

50. A non-transitory computer storage medium, storing an executable program, wherein the executable program, when executed by a processor, enables the method of claim 1.
